(19) United States
(12) Patent Application Publication
(10) Pub. No.: US 2001/0031650 A1
(43) Pub. Date: Oct. 18, 2001

(54) Method for optimizing a user signal in a voice terminal, and a voice terminal

(76) Inventors: Stefan Baiker, Basel (CH); Urs Fankhauser, Langendorf (CH)

Correspondence Address: Richard G. Lione, BRINKS HOFER GILSON & LIONE, P.O. Box 10395, Chicago, IL, 60610, US

(21) Appl. No.: 09/738,256

(22) Filed: Dec. 14, 2000

(30) Foreign Application Priority Data
Dec. 16, 1999 (EP) 99125064.8

(51) Int. Cl. H04B 1/10

(52) U.S. Cl. 455/570; 455/219; 455/221

(57) ABSTRACT

The method is used for optimizing a user signal, which is to be transmitted, in a stationary or mobile voice terminal by means of which a user signal consisting of a voice signal and a first background signal is picked up via a microphone, is supplied, possibly after analog or digital signal processing, to an output stage and is delivered by the latter to a transmission medium. In the voice terminal, a memory unit is provided in which at least one second background signal is stored which is called up by a control unit and is superimposed during the entire period or part of the period of the call on the voice signal to be transmitted.

### BACKGROUND OF THE INVENTION

The invention relates to a method for optimizing a user signal, which is to be transmitted, in a voice terminal and to a voice terminal according to the preamble of claim 1 and 7, respectively.

### BRIEF SUMMARY OF THE INVENTION

In the communication between mobile and/or stationary voice terminals of a communication system, e.g. an ISDN telecommunication system, user signals are transmitted which consist of voice, background and interference signals.

In addition to the voice of a subscriber, the background noises prevailing in its environment are also picked up at a message source by means of a microphone provided in the voice terminal. The user signal emitted by the microphone thus consists of voice and background signals on which in most cases smaller interference signals are superimposed in the voice terminal and during the transmission which are normally largely eliminated by filters, echo cancellers and regenerative repeaters before they reach the message sink (see, e.g., [1], Peter Bocker, ISDN-Digitale Netze für Sprach-, Text-, Daten-, Video- und Multimediakommunikation, Springer Verlag, Berlin 1997, Pages 245-246 [Digital ISDN networks for voice, text, data, video and multimedia communication, SpringerVerlag, Berlin 1997, pages 245-246]).

The user signal can be transmitted in analog or digital form. Voice terminals which are suitable for digital signal processing and coupling to digital networks such as ISDN are described, for example, in [1], Chapter 5.1, pages 165-179.

It is known that background signals can considerably influence and possibly considerably impair the voice communication between two parties to a call.

In particular, it was found that, in addition to loud background noises which impair the intelligibility, noises of lower intensity can also be felt to be disturbing.

### SUMMARY OF THE INVENTION

The invention is, therefore, based on the object of specifying a method by means of which a user signal to be transmitted can be optimized in a stationary or mobile voice terminal. Furthermore, a voice terminal suitable for applying the method is to be specified.

The method according to the invention allows a user signal which is to be transmitted to be optimized in a stationary or mobile voice terminal. To this end, the user signal consisting of a voice signal and a first background signal is supplied to an adding stage connected to an output stage where a second background signal, which can be called up from a memory unit, is superimposed on it. The first background signal picked up together with the voice signal is preferably suppressed by a filter before the second background signal is superimposed on the user signal or voice signal, respectively.

The second background signal is preferably formed by picking up a current first background signal by means of the microphone of the voice terminal or by transmitting a signal from another signal source into the memory unit where it is stored.

A stored second background signal is preferably selected as a function the call number and/or the date and/or the time of day set or randomly.

To ensure optimum intelligibility, the intensity of the second background signal called up from the memory unit is preferably regulated as a function of the intensity of the voice signal, preferably tracking the mean voice power.

To separate the first background signal optimally from the voice signal, an adaptation to the voice signal or, respectively, to the voice of the user of the voice terminal is preferably effected.

Thus, the method allows interfering background noises of high or lesser intensity to be eliminated. Due to the second background signal adapted to the current situation, the communication between the parties to the call can be improved not only at the acoustical level. Instead of interfering background noises, it is possible to inject, e.g., classical music so that an improvement in communication is also achieved at the non-technical level.

Furthermore, applications are also conceivable in which it is not the situation existing in reality but a preferred virtual situation at the site of the user which is conveyed to the party to the call. This is especially useful particularly for service providers including emergency and assistance services since the exchange of information can be assisted by these measures.

The method according to the invention can be applied in any stationary or mobile voice terminals such as, e.g., in ISDN, GSM, UMTS or DECT terminals but also in traditional analog telecommunication terminals or simple transceivers.

### BRIEF DESCRIPTION OF SEVERAL VIEWS OF THE DRAWINGS

In the text which follows, the invention will be explained in greater detail with reference to a drawing, in which:

The single figure shows a diagrammatic representation of the configuration of a mobile or stationary voice terminal 100a according to the invention.

### DETAILED DESCRIPTION OF THE INVENTION

Referring to the drawing, a voice terminal 100a embodying features of the invention is shown. The terminal 100a can contact another voice terminal 100b via a transmission line 13 or by radio via an antenna 8. The voice terminal 100a exhibits a control unit 3 which is connected to a keypad 4, a display device 5 and a memory unit 2.

Furthermore, a microphone 1 is provided from which a user signal consisting of a voice signal and a first background signal can be supplied via a filter 12 to the first input 61 of an adding stage 6 and from its output via a coupling stage 7 containing, e.g., an input amplifier and an output amplifier to the antenna 8 or the transmission line 13. The microphone 1 is also connected via an analog/digital converter 9 to the memory unit 2 which, in turn, is connected to the second input 62 of the adding stage 6 via a digital/analog converter 10.

User signals of the further voice terminal 100b supplied by the antenna 8 or the transmission line 13 are delivered to a loudspeaker 11 after any processing which takes place in the coupling stage 7 or in input stages (not shown).

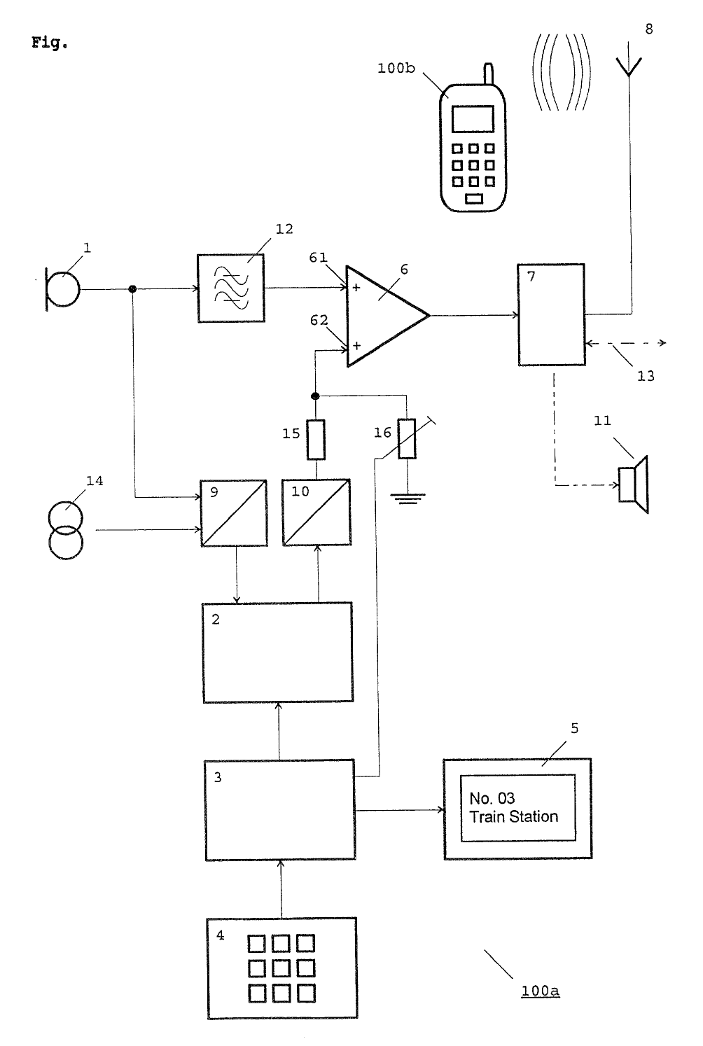

If a connection to a telecommunication network is provided, the voice terminal 100a also exhibits control and signaling modules which are used for setting up a connection (see, e.g., [1], page 171, FIG. 5.5). Depending on the transmission method selected, modules are also provided by means of which corresponding analog or digital signal processing (digitization, coding, framing) is performed.

According to the invention, in the adding stage 6, a second background signal which is called up from the memory unit 2 and supplied to the adding stage 6 via the digital/analog converter 10 is superimposed on the user signal supplied by the microphone I and consisting of a voice signal and possibly a first background signal.

One of the preferably several second background signals which are stored in the memory unit 2 is selected, e.g. manually via the keypad 4 or automatically by the control unit 3, preferably as a function of the call number and/or the date and/or the time of day set or randomly.

The second background signal is preferably superimposed on the user signal at the start of the call or immediately after the connection has been set up. In a case of manual operation, a second background signal can also be added and/or disconnected again, for example, at any time after the call has been set up.

Combining a second background signal with a call number has the advantage that a uniform appearance is produced in communicating with call partners. In communication with business partners, for example, discreet background music is in each case selected in order to generate a pleasant conversational atmosphere with optimum intelligibility. The selection as a function of date and/or time of day allows automatic adaptation to background noises to be expected.

The background signal set and possibly also its intensity are preferably displayed on the display device 5.

In a preferred embodiment of the invention, the intensity of the second background signal called up from the memory unit 2 can be controlled or regulated. For example, the user can preset a desired intensity via the keypad 4. However, regulation as a function of the intensity of the voice signal which is averaged over a certain time interval is preferred.

The intensity is set in the voice terminal 100a by supplying the signal emitted by the digital/analog converter 10 via a first resistor 15 to an input of the adding stage 6 which is additionally connected to a second resistor 16 which can be controlled by means of the control unit 3.

Superimposing the second background signal on the user signal picked up by the microphone 1 produces a mixture of two background signals which can be felt to be disturbing. Therefore, the first background signal is preferably attenuated by the filter 12 so that essentially only the voice signal and the second background signal are added in the adding stage 6.

To separate the voice signal optimally from the first background signal, the filter 12 preferably performs an adaptation to the voice signal. Such filter techniques are described, for example, in [2], U.S. Pat. No. 5,884,251. In this arrangement, the frequency spectrum of the voice signal is determined by the means of various filter modules by means of iterative signal processing and prediction. After the frequency spectrum of the voice signal has been determined, the passband characteristic of the filter is appropriately adapted.

Second background signals are preferably recorded in the memory unit 2 by means of the microphone 1 by means of which a current (first) background signal is detected and transmitted into the memory unit 2 via the analog/digital converter 9. However, second background signals can also be recorded in the memory unit 2 from other signal sources 14, possibly after analog/digital conversion.

The method according to the invention can be used in any, preferably mobile voice terminals such as, e.g., in ISDN, GSM, UMTS or DECT terminals but also in traditional analog telecommunication terminals or simple transceivers. A voice terminal according to the invention can also be a part of a communication terminal which is additionally adapted for transmission of image information and/or other information.

In a preferred embodiment, a signal processor in which the modules 2, 3, 6, 9, 10, 12, 15 and/or 16 shown in the figure are implemented as hardware or software can also be used in a voice terminal according to the invention.

While a preferred embodiment of the invention has been described, it should be understood that the invention is not so limited, and modifications maybe made without departing from the invention. The scope of the invention is defined by the appended claims, and all devices that come within the meaning of the claims, either literally or by equivalence, are intended to be embraced therein.

1. A method for optimizing a user signal, which is to be transmitted, in a stationary or mobile voice terminal by means of which a user signal consisting of a voice signal and a first background signal is picked up via a microphone, is supplied, possibly after analog or digital signal processing, to an output stage and is delivered by the latter to a transmission medium, wherein, in the voice terminal, a memory unit is provided in which at least one second background signal is stored which is called up by a control unit and is superimposed during the entire period or parts of the period of the call on the user signal to be transmitted.

2. The method as claimed in claim 1, wherein a current first background signal picked up by the microphone or a signal from another signal source is transmitted into the memory unit from where it is called up, if necessary, now as second background signal, by means of the control unit.

3. The method as claimed in claim 1, wherein a stored second background signal is selected manually via the keypad of the voice terminal or as a function of the call number and/or the date and/or the time of day set or randomly.

4. The method as claimed in claim 1, wherein the intensity of the second background signal called up from the memory unit is regulated, particularly as a function of the intensity of the voice signal.

5. The method as claimed in claim 1, wherein the first background signal picked up together with the voice signal is suppressed by a filter before the second background signal called up from the memory unit is superimposed on the voice signal.

6. The method as claimed in claim 5, wherein the filter performs an adaptation to the voice signal.

7. A mobile or stationary voice terminal comprising a memory unit, a control unit and a microphone by which a user signal consisting of a voice signal and a first background signal can be delivered to a transmission medium via a coupling stage, wherein an adding stage is provided in which, controlled by the control unit, a second background signal which can be called up from the memory unit can be superimposed on the user signal supplied by the microphone.

8. The voice terminal as claimed in claim 7, wherein a current first background signal picked up by means of the microphone or a signal from another signal source can be transmitted into the memory unit, possibly via an analog/digital converter, from where it can be called up again by the control unit possibly via a digital/analog converter.

9. The voice terminal as claimed in claim 7, wherein a stored second background signal can be selected manually via the keypad of the voice terminal or as a function of the call number and/or the date and/or the time of day set or randomly.

10. The voice terminal as claimed in claim 7, wherein the intensity of the second background signal called up from the memory unit can be regulated manually or by the control unit, particularly as a function of the intensity of the voice signal.

11. The voice terminal as claimed in claim 7, wherein a filter suitable for suppressing the first background signal is provided via which the user signal picked up by the microphone can be supplied to the adding stage.

12. The voice terminal as claimed in claim 11, wherein the filter can perform an adaptation to the voice signal.
